(19) United States
(12) Patent Application Publication
(10) Pub. No.: US 2007/0039410 A1
(43) Pub. Date: Feb. 22, 2007

(54) Wrapped steering wheel and method

(75) Inventor: William E. Bostick, Saint Clair, MI (US)

Correspondence Address: FOLEY AND LARDNER LLP;SUITE 500, 3000 K STREET NW, WASHINGTON, DC, 20007, US

(73) Assignee: TAKATA-PETRI INC.

(21) Appl. No.: 11/207,019

(22) Filed: Aug. 19, 2005

(51) Int. Cl. B62D 1/04; G05G 1/10

(52) U.S. Cl. 74/552

(57) ABSTRACT

A steering wheel includes a steering ring having a first channel and a second channel and a covering coupled to the steering ring. A first edge of the covering is secured within the first channel with a first member and a second edge of the covering is secured within the second channel with a second member.

### BACKGROUND

The present invention relates generally to steering wheels for use in automobiles. More specifically, the present invention relates to steering wheels that are wrapped with a material (e.g., leather) and a method for producing such steering wheels.

Steering wheels used in automobiles and the like may have a covering material applied thereto for aesthetic or other reasons. Such covering materials may include, for example, leather or vinyl materials. The covering materials may be provided around the steering ring in the location where a driver will grip the steering wheel.

One known method for attaching a covering material to a steering wheel involves wrapping the covering material around the ring portion of the steering wheel and stitching the covering material to itself. In certain applications, an adhesive may also be used to secure the covering material to the ring.

One difficulty with such known method is that the stitching operation may be relatively labor intensive and expensive. Even in cases where the stitching operation is performed by a machine, the time required to stitch the covering material may result in increased cycle times and variability between products.

It would be desirable to provide a method for providing a covering material on a steering wheel that is relatively simple and inexpensive. It would also be desirable to provide a method for applying a covering material for a steering wheel that may be partially or completely automated and which may reduce variability and cycle times for manufacturing the steering wheel. It would further be desirable to provide a method for providing a covering material for a steering wheel that eliminates the need to utilize an adhesive or a stitching operation.

### SUMMARY

The present invention relates to a steering wheel that includes a steering ring having a first channel and a second channel and a covering coupled to the steering ring. A first edge of the covering is secured within the first channel with a first member and a second edge of the covering is secured within the second channel with a second member.

The present invention also relates to a steering wheel for a vehicle that includes a ring having a core and a cladding and a cover material coupled to the ring such that a first edge of the cover material is received in a first cutout provided in the cladding and a second edge of the cover material is received in a second cutout provided in the cladding. A first element is provided for securing the first edge in the first cutout, at least a portion of the first element being received in the first cutout. A second element is also provided for securing the second edge in the second cutout, at least a portion of the second element being received in the second cutout.

The present invention also relates to a method for wrapping a steering wheel with a material that includes providing a first edge of a strip of material into a first channel formed in a steering ring of a steering wheel along with at least a portion of a first member. The method also includes wrapping the strip of material around at least a portion of the steering ring. The method further includes providing a second edge of the strip of material into a second channel provided in the steering ring along with at least a portion of a second member.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is a front plan view of a portion of a steering wheel according to an exemplary embodiment.

FIG. 2 is a cross-sectional view of the steering wheel shown in FIG. 1 taken across line 2-2.

FIG. 3 is a flow diagram illustrating steps in a method of securing a covering material to a steering wheel according to an exemplary embodiment.

FIG. 4 is a sectional view of a portion of a steering wheel similar to that shown in FIG. 1 illustrating the insertion of a covering material into a first slot or channel.

FIG. 5 is a sectional view of the portion of a steering wheel shown in FIG. 3 illustrating the folding of the covering material.

FIG. 6 is a sectional view of a portion of the steering wheel shown in FIG. 3 illustrating the insertion of another portion of the covering material into a second slot or channel.

FIG. 7 is a sectional view of a portion of the steering wheel shown in FIG. 3 illustrating the insertion of another portion of the covering material into a second slot or channel according to another exemplary embodiment.

FIG. 8 is a rear plan view of a portion of a steering wheel according to another exemplary embodiment.

FIG. 9 is a perspective view of a portion of the steering wheel shown in FIG. 7.

FIG. 10 is a sectional view of a portion of the steering wheel shown in FIG. 7 taken across line 9-9 in FIG. 8.

FIG. 11 is a sectional view of a portion of a steering wheel similar to that shown in FIG. 7 according to another exemplary embodiment.

### DETAILED DESCRIPTION

According to exemplary embodiment, a steering wheel having a covering material or layer (e.g., leather, vinyl, or any of a variety of polymeric materials) provided on a portion thereof may be produced using a method in which the covering is coupled to the steering wheel without the need to stitch the covering. In this manner, the process for applying the covering to the steering wheel may be partially or entirely automated.

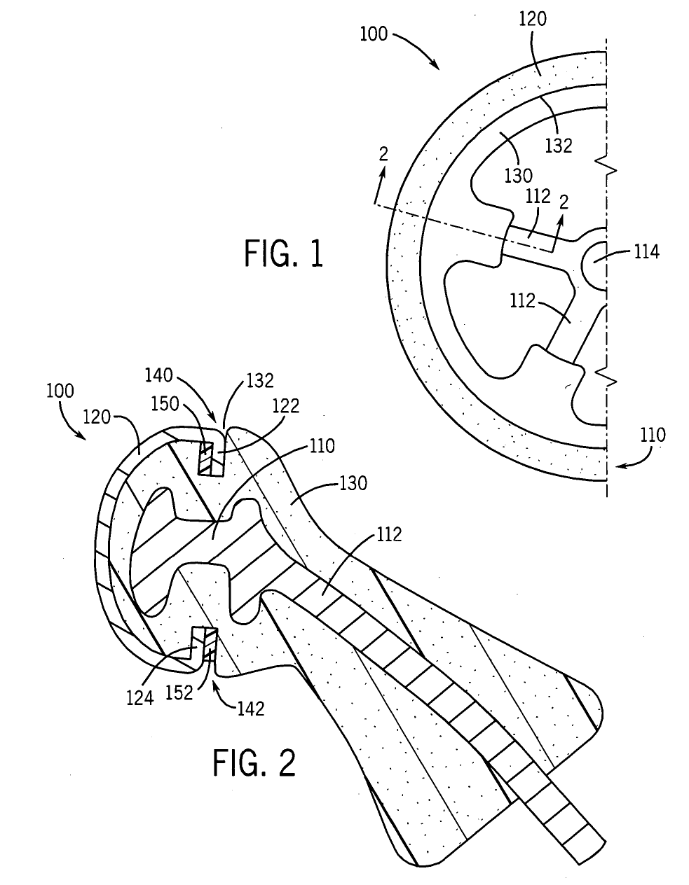

As shown in FIG. 1, a steering wheel 100 includes a steering ring 110 coupled to a plurality of armatures or spokes 112 which are joined at a hub 114 according to an exemplary embodiment. The steering ring 110 and armatures 112 may be made of any suitable material (e.g., a metal, polymeric, or composite material) and may have any of a variety of shapes, sizes, and configurations according to various other exemplary embodiments. One or both of the steering ring 110 and the armatures 112 may include a cladding layer or material 130 (e.g., a polymeric material).

According to an exemplary embodiment, a covering material or layer 120 is coupled or attached to the steering ring 110 in the region where a driver of a vehicle will grip the steering wheel 100. The covering material 120 may be coupled directly to the steering ring 110 or to a cladding material or layer 130 that may be coupled to the steering ring 110 and/or the armatures 112. The covering material 120 forms an interface or boundary 132 with the cladding material 130, as shown in FIGS. 1 and 2. According to an exemplary embodiment, the boundary 132 is formed such that no stitching between the covering material 120 and the cladding material 130 is required, as will be discussed in greater detail below.

The covering material 120 may be made of any suitable material. According to an exemplary embodiment, the covering material 120 is a natural or synthetic leather material. According to other exemplary embodiments, the covering material 120 may be a polymeric material such as vinyl or any other suitable material. The covering material 120 may be provided as a strip of material that is wrapped around at least a portion of the steering ring 110, and may have any suitable size, shape, and configuration as may be appropriate for a particular application.

As shown in FIG. 2, a first side or edge 122 of the covering material 120 is provided in a channel or cutout 140 provided in a portion of the steering wheel (e.g., in the cladding layer 130). A second side or edge 124 of the covering material 120 is provided in a second channel or cutout 142 provided in a portion of the steering wheel (e.g., in the cladding layer 130). It should be noted that according to an exemplary embodiment in which no cladding layer (e.g., cladding layer 130) is provided, the channels or apertures may be provided in the steering ring and/or in the armature.

To secure the edges 122 and 124 of the covering material 120 within the channels 140 and 142, respectively, members or elements 150 and 152 (e.g., retaining members) are provided within the channels 140 and 142 adjacent or proximate to the edges 122 and 124 of the covering material 120. The members 150 and 152 may be provided in the form of press rings which extend along the entire length of the channels 140 and 142. According to other exemplary embodiments, the members 150 and 152 may extend only a portion of the way along the channels 140 and 142 (e.g., multiple members may be provided within a single channel at various points along the channel).

The size, shape, and configuration of the members 150 and 152 may be selected so as to provide a relatively tight fit to secure the edges 122 and 124 of the covering material 120 within the channels 140 and 142. That is, the members 150 and 152 may have a size such that insertion of both an edge of the covering material and the member 150 or 152 may be relatively difficult so as to ensure a secure fit within the channel.

One advantageous feature of providing members 150 and 152 within the channels 140 and 142 along with the edges 122 and 124 of the covering material 120 is that the covering material 120 may be secured to the steering wheel 100 without the need to provide stitching between the covering material 120 and itself or between the covering material 120 and another part of the steering wheel (e.g., the cladding layer 130).

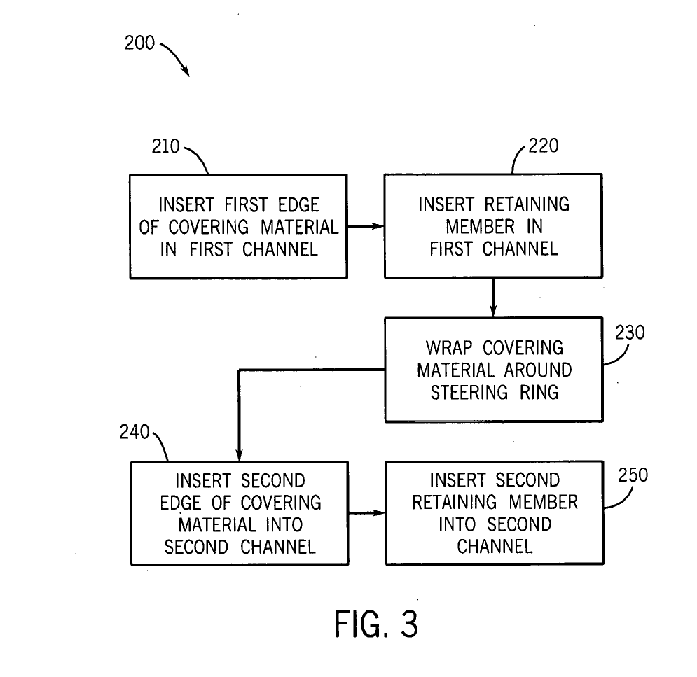

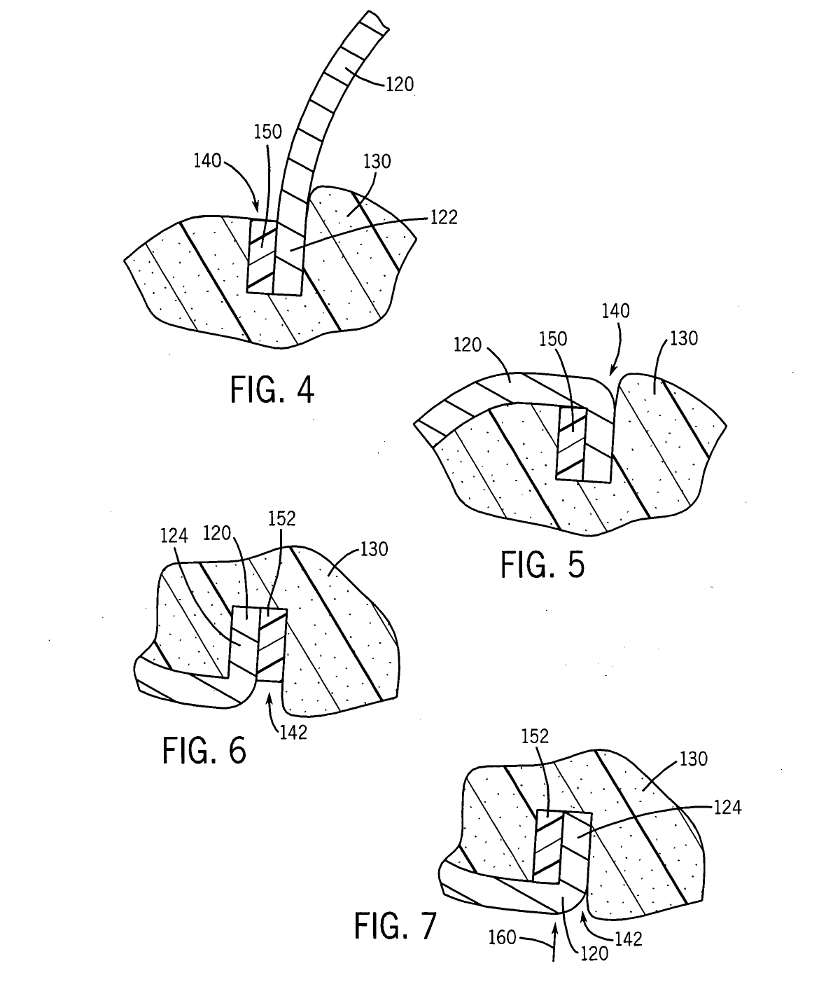

FIG. 3 illustrates steps in a method 200 for securing or attaching a covering material (e.g., the covering material 120) to a steering wheel (e.g., steering wheel 100) according to an exemplary embodiment. FIGS. 4-7 are sectional views of a portion of the steering wheel 100 shown in FIG. 1 illustrating the steps in the method 200.

As shown in FIG. 4, according to a step 210, the first edge 122 of the covering material 120 is inserted into a channel 140. In a step 220, after providing or positioning the first edge 122 of the covering material 120 within the channel 140, the member 150 is inserted within the channel 140 proximate or adjacent to the first edge 122 of the covering material 120. Insertion of the member 150 acts to relatively securely attach the first edge 122 of the covering material 120 within the channel 140.

In a step 230 shown in FIG. 5, the covering material 120 is wrapped around the steering ring 110 and the cladding layer 130 such that the covering material 120 is provided in contact with the cladding layer 130 (e.g., or, according to another exemplary embodiment, the covering material 120 is provided in direct contact with the steering ring 110).

In a step 240 shown in FIG. 6, the second edge 124 of the covering material 120 is inserted into the second channel 142. In a step 250 shown in FIG. 6, after the second edge 124 is provided within the channel 142. The second member 152 is also provided within the channel 142 to secure the second edge 124 of the covering material 120 within the channel 142.

According to the exemplary embodiment shown in FIG. 6, the first edge 124 of the covering material 120 may be provided within the channel 142 prior to the insertion of the member 152. In this manner, an observer of the steering wheel viewing the channel 142 may be able to view the member 152. That is to say, the member 152 is not covered or obscured by the covering material 120 (e.g., for aesthetic or manufacturing reasons). According to another exemplary embodiment, both the member 150 and the member 152 may be visible to an observer of the steering wheel for aesthetic or manufacturing reasons.

According to another exemplary embodiment shown in FIG. 7, the covering material 120 may be provided such that it covers or obscures the member 152 when the second edge 124 of the covering material 120 is inserted within the channel 142 (e.g., similar to the manner in which the covering material 120 covers or obscures the member 150 as shown in FIG. 5). To accomplish this arrangement, the member 152 and the second edge 124 of the covering material 120 are inserted within the channel 142 simultaneously. The member 152 and the second edge 124 of the covering material 120 are placed in contact with each other and are pressed or pushed into the channel 142 by a force illustrated by arrow 160 in FIG. 7. In this manner, the covering material 120 may be relatively securely attached to the steering ring 110 such that both members 150 and 152 are covered by the covering material 120.

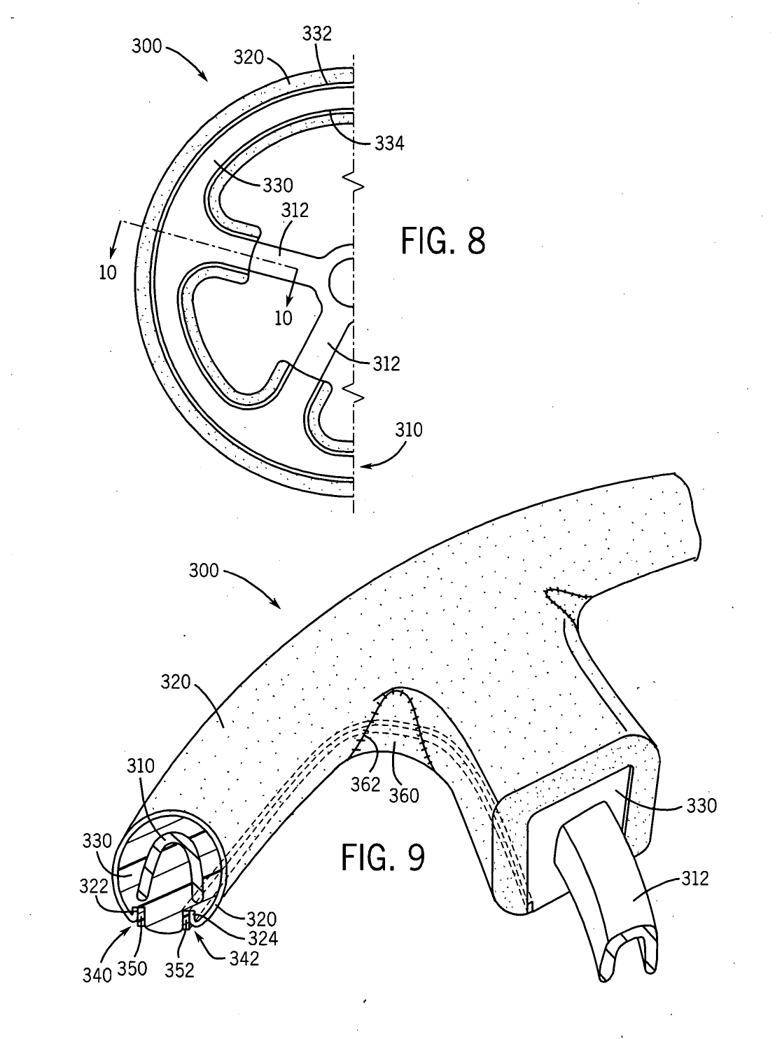

While FIGS. 1 to 2 illustrate an arrangement in which the interface 132 between the cladding layer 130 and the covering material 120 is provided on a front surface of the steering wheel 100, according to other exemplary embodiments, the covering material may be affixed to the steering wheel in other ways. For example, FIG. 8 illustrates a rear view of a steering wheel 300 according to another exemplary embodiment. The steering wheel 300 includes a steering ring 310 and armatures or spokes 312 having a cladding layer or material 330 provided thereon. As shown in FIG. 8, interfaces 332 and 334 between the cladding layer 330 and a covering material or layer 320 are both provided on the rear side of the steering wheel 300.

As shown in FIG. 9, members 350 and 352 are inserted into channels 340 and 342 along with a first edge 322 and a second edge 324 of the covering material 320. As illustrated in FIG. 9, both of the members 350 and 352 may be visible to a viewer observing the rear surface of the steering wheel 300. According to another exemplary embodiment (not shown), both of the members 350 and 352 may be obscured by inserting both the members and the corresponding edges of the covering material 320 into the channels 340 and 342 simultaneously (e.g., as illustrated in FIG. 7).

A patch 360 of material similar or identical to the covering material 320 may be stitched along a line 362 at the intersection of the steering ring 310 and the armature 312 to provide complete coverage for the portion of the steering wheel assembly shown in FIG. 9. It should be noted that such a patch may also be provided in other exemplary embodiments in which the covering material 320 extends over a portion of the armature 312.

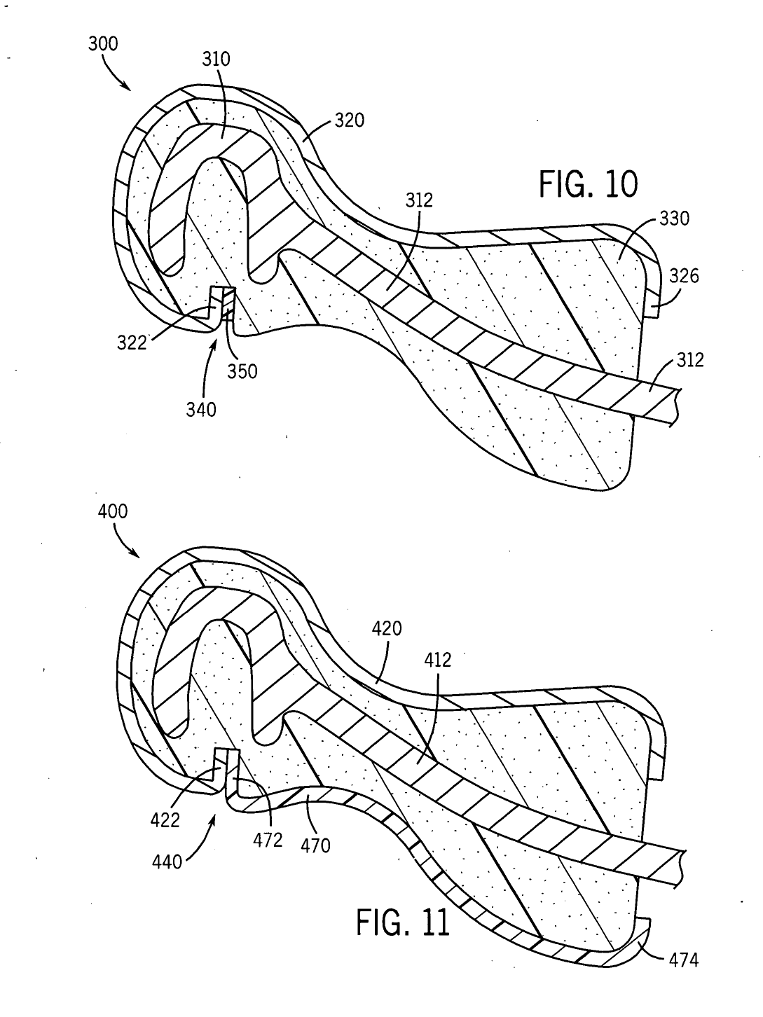

FIG. 10 illustrates a cross-sectional view of the steering wheel 300 taken along line 10-10 in FIG. 8. As shown in FIG. 10, in the region where the armature 312 intersects the steering ring 310, one of the edges (e.g., edge 322) of the covering material 320 is provided within a channel (e.g., channel 342). Another edge (e.g., edge 326 shown in FIG. 10) is provided in contact with the cladding layer 330. The edge 326 may be coupled to the cladding layer 330 by any suitable means (e.g., adhesive, etc.).

While the preceding FIGURES have illustrated the use of retaining members in the form of press rings (e.g., member 150) provided entirely within channels, FIG. 11 illustrates another exemplary embodiment in which a member or element 470 in the form of a backing plate may be provided in place of the press ring. As shown in FIG. 11, a steering wheel 400 includes a covering material 420 having a first edge 422 inserted within a channel 440 along with a portion of the member 470. A first edge 472 of the member 470 is inserted into the channel 442 after insertion of the first edge 424 of the covering material 420. A second edge 474 extends inward along the armature 412. In this manner, the member 470 forms a backing plate for the steering wheel. The member 470 may be made of any suitable material, including a hard plastic material, a metal, or any other suitable material. According to one exemplary embodiment, the member 470 may be made of a material similar to that used for the covering material 420.

It should be noted that the members described herein (e.g., members 150, 152, 350, 352, and 472) may have any of a variety of forms or configurations and may be formed of any of a variety of suitable materials. Such members may be self-locking, glued, or fixed to the steering wheel and may also be pre-attached to the covering materials in a variety of ways to facilitate automated assembly (i.e., may be glued, snapped, hooded, stitched, etc.). The channels in which the members are provided may include undercuts in the molding process to improve securing the cladding and/or improve the appearance or fit of the cladding.

It will be appreciated by those of ordinary skill in the art reviewing this disclosure that many advantages may be obtained using the methods and systems described herein. For example, the process for applying a covering material (e.g., leather) to a portion of a steering wheel may be automated to reduce the cost, labor, cycle time, and variability associated with producing the steering wheel. For example, one or more pieces of manufacturing equipment may be used to perform all steps in the method described (e.g., inserting the edges of the covering material into channels along with retaining members such as members 150 and 152 shown in FIG. 2). For example, according to one exemplary coupling method described herein, channels are formed in the top and the bottom of a steering wheel ring (e.g., at the front and back surfaces of the steering wheel, where the front surface faces the driver and the back surface is obscured from the driver when the steering wheel is installed in a vehicle), which is typical with the direction of the tool form, which facilitates the manufacturability and automation used to form the steering wheels. In another embodiment, both the channels are formed at the rear of the steering ring so as to be obscured from the driver when the steering wheel is installed in a vehicle.

Another advantageous feature of the methods described herein is that the need to provide stitching for a covering material for a steering wheel may be eliminated. By eliminating the need to provide stitching, the process for covering portions of steering wheels with covering materials may be expedited, which may result in increased throughput and reduced manufacturing costs. The interface between the covering material and the steering wheel may also be more aesthetically pleasing than in cases where stitching or other methods may be utilized.

It is important to note that the construction and arrangement of the steering wheel as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. Other substitutions, modifications, changes and omissions may be made in the design, operating conditions and arrangement of the preferred and other exemplary embodiments without departing from the scope of the present inventions as expressed in the appended claims.

What is claimed is:

1. A steering wheel comprising:
a steering ring comprising a first channel and a second channel; and
a covering coupled to the steering ring;
wherein a first edge of the covering is secured within the first channel with a first member and a second edge of the covering is secured within the second channel with a second member;
wherein at least one of the first member and the second member are covered by the covering.

2. The steering wheel of claim 1, wherein the first channel is provided in a front portion of the steering ring and the second channel is provided in a rear portion of the steering ring, the front portion of the steering ring facing a driver of a vehicle when the steering wheel is installed in the vehicle.

3. The steering wheel of claim 1, wherein the first channel and the second channel are provided in a rear portion of the steering ring, the rear portion of the steering ring being not visible to a driver of a vehicle when the steering wheel is installed in the vehicle.

4. The steering wheel of claim 1, wherein the steering ring comprises a core and a cladding and the first channel and the second channel are provided in the cladding.

5. The steering wheel of claim 1, wherein at least one of the first channel and the second channel have an undercut for facilitating assembly of the steering wheel.

6. The steering wheel of claim 1, wherein the cladding surrounds the steering ring and at least a portion of an armature attached to the steering ring.

7. The steering wheel of claim 1, wherein the covering comprises a material selected from leather and a polymeric material.

8. The steering wheel of claim 1, wherein the covering extends around the entire circumference of the steering wheel.

9. The steering wheel of claim 1, wherein the covering extends around a portion of the circumference of the steering wheel.

10. The steering wheel of claim 1, wherein the first member and the second member comprise press rings for providing a pressure fit between the covering and the channels.

11. The steering wheel of claim 1, wherein both the first member and the second member are covered by the covering.

12. The steering wheel of claim 11, wherein the first member and the second member are not visible to an observer of the steering wheel when the covering is coupled to the steering ring.

13. A steering wheel for a vehicle comprising:
a ring having a core and a cladding;
a cover material coupled to the ring such that a first edge of the cover material is received in a first cutout provided in the cladding and a second edge of the cover material is received in a second cutout provided in the cladding;
a first element for securing the first edge in the first cutout, at least a portion of the first element being received in the first cutout; and
a second element for securing the second edge in the second cutout, at least a portion of the second element being received in the second cutout;
wherein the cover material is coupled to the ring such that it obscures from view at least one of the first element and the second element.

14. The steering wheel of claim 13, wherein the first cutout is provided in a front portion of the steering wheel and the second cutout is provided in a rear portion of the steering wheel.

15. The steering wheel of claim 13, wherein the first cutout and the second cutout are provided in a rear portion of the steering wheel.

16. The steering wheel of claim 13, wherein the cover material covers both the first element and the second element.

17. The steering wheel of claim 16, wherein the cover material covers the first element.

18. The steering wheel of claim 13, wherein the cover material comprises a material selected from the group consisting of leather and a polymeric material.

19. The steering wheel of claim 13, wherein the cover material is coupled to the ring without the use of stitching.

20. The steering wheel of claim 13, wherein the second element extends out of the second cutout and away from the second cutout.

21. The steering wheel of claim 13, wherein the first member and the second member comprise press rings extending along the entire length of the cutouts.

22. The steering wheel of claim 13, wherein the first member and the second member comprise press rings extending a portion of the length of the cutouts.

23. A method for wrapping a steering wheel with a material comprising:
providing a first edge of a strip of material into a first channel formed in a steering ring of a steering wheel along with at least a portion of a first member;
wrapping the strip of material around at least a portion of the steering ring such that the strip of material covers the first member; and
providing a second edge of the strip of material into a second channel provided in the steering ring along with at least a portion of a second member.

24. The method of claim 23, wherein at least one of the first channel and the second channel are provided in a location of the steering ring not facing a driver of a vehicle when the steering wheel is installed in the vehicle.

25. The method of claim 23, wherein the strip of material comprises at least one of leather and a polymeric material.

26. The method of claim 23, further comprising inserting the first member and the first edge into the first channel simultaneously.

27. The method of claim 23, wherein the step of wrapping the strip of material comprises folding the strip of material such that the first member is covered by the strip of material.

28. The method of claim 27, wherein the step of providing the second edge of the strip of material into the second channel comprises inserting the second edge and the second member such that the strip of material covers the second member.

29. The method of claim 28, wherein the step of providing the second edge of the strip of material into the second channel comprises inserting the second edge and the second member such that the strip of material does not cover the second member.

30. The method of claim 23, wherein the method does not utilize stitching to secure the strip of material to the steering ring.

31. The method of claim 23, wherein the second member comprises a back plate and the step of providing the second edge of the strip of material into the second channel comprises inserting a portion of the second member into the second channel.
